(19) United States
(12) Patent Application Publication
(10) Pub. No.: US 2008/0055359 A1
(43) Pub. Date: Mar. 6, 2008

(54) Print Head, Print Head Assembly, Cartridge And Printer

(75) Inventors: Mark Theo Meuwese, Eindhoven (NL); Maria Van Wely-Dieleman, Eindhoven (NL); Paulus Cornelis Duineveld, Drachten (NL); Johan Frederik Dijksman, Eindhoven (NL); Marinus Josephus Jakobus Dona, Veldhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,147

(22) PCT Filed: Sep. 14, 2005
(86) PCT No.: PCT/IB05/53020

§ 371 Date: Mar. 13, 2007

(30) Foreign Application Priority Data
Sep. 16, 2004 (EP) 04104483.5

(51) Int. Cl. B41J 2/145; B41J 2/175

(52) U.S. Cl. 347/40; 347/86

(57) ABSTRACT

A print head has a face (6) presenting an array of nozzle orifices (7) and is configured for mounting a number of associated ejection arrangements, each ejecting droplets of printing fluid through the associated nozzle (8) when activated. The print head includes at least parts of a plurality of reservoir arrangements (27,28) for holding printing fluids to be ejected and a channel arrangement (9,14,15) for supplying a printing fluid from a reservoir arrangement (27,28) to an individual nozzle (8). The print head includes at least one adapter structure (11,13) for releasable connection to a cartridge (4; 16) including a container (5;22) for holding a printing fluid. The adapter structure (11,13) is configured to co-operate with the cartridge (4; 16) to provide a passage between the container (5;22) and channel arrangement upon connection.

The invention relates to a print head having a face presenting an array of nozzle orifices and configured for mounting a number of associated ejection arrangements, each ejecting droplets of printing fluid through the associated nozzle when activated, wherein the print head includes at least parts of a plurality of reservoir arrangements for holding printing fluids to be ejected and a channel arrangement for supplying a printing fluid from a reservoir arrangement to an individual nozzle.

The invention also relates to a print head assembly including
a print head having a face presenting an array of nozzle orifices and including
a number of associated ejection arrangements for each ejecting droplets of printing fluid through the associated nozzle when activated,
the assembly including a plurality of reservoir arrangements for holding fluids to be ejected, wherein the print head includes a channel arrangement for supplying a printing fluid from a reservoir arrangement to an individual nozzle.

The invention also relates to a cartridge for use in a print head assembly.

The invention also relates to a printer.

Examples of a print head and print head assembly of the types mentioned above are known from U.S. Pat. No. 6,461,812B2. This publication discloses a multiple-reservoir deposition apparatus including an orifice member and a back member and a barrier situated at least partly between them, so that the orifice member, the barrier member and the back member together define a number of delivery chambers. In each of the delivery chambers propelling means such as a heater or an electromechanical device is associated with each orifice in the orifice member such that when activated the propelling means causes a quantity of fluid to pass out through the orifice from the delivery chamber. In one embodiment, there are sixteen separate reservoirs, each in fluid communication with a single delivery chamber each having an orifice and associated propelling means. Each reservoir, which is separated from all the others but is not separate from the delivery chamber it supplies, is defined by the walls of an opening in the back member. The delivery chambers can be filled either by introducing fluids to the reservoirs through supply ports in the cover associated with each reservoir, and then as may be needed employing a pressure differential or change in pressure differential to force the fluids into the delivery chambers and to the orifices; or, the fluids can be drawn into the different chambers and reservoirs by contacting each orifice with a different fluid and then employing a pressure differential as may be needed to draw the fluids into the delivery chambers and the reservoirs.

Thus, to prepare the device for printing a few droplets of fluid, the fluid concerned must be provided in a dish to suck it into one of the delivery chambers or one of the reservoirs must be filled. Due to the risk of contamination, any remainder after printing cannot be recycled. A problem of the known device is therefore that a relatively large quantity of fluid is needed to propel a desired amount from a delivery chamber.

It is an object of the invention to provide a print head, print head assembly and cartridge allowing dense printing of droplets of precious fluids in a relatively efficient manner. An example of printing of such precious fluids is printing for the production of biosensors, where a high number of different fluids (capture probes) has to be printed in a specific pattern on small substrates (porous membranes).

This object is achieved by the print head according to the invention, which is characterized in that the print head includes at least one adapter structure for releasable connection to a cartridge including a container for holding a printing fluid, wherein the adapter structure is configured to co-operate with the cartridge to provide a passage between the container and channel arrangement upon connection.

By the use of a print head having a face presenting an array of nozzle orifices, relatively dense printing is made possible, even when the print head is kept immobile relative to the surface onto which droplets are deposited. By having a corresponding number of associated ejection arrangements for ejecting droplets of printing fluid through the associated nozzle, it is possible to eject droplets through an individual one of the nozzles. This is more efficient, since the fluid need only be supplied to that nozzle. In combination with a channel arrangement for supplying a printing fluid from a reservoir arrangement to an individual nozzle, less of the print head need be flushed after use, so that correspondingly little of the printing fluid is wasted. The reservoir arrangement including a cartridge including a container for holding a printing fluid provides a removable reservoir for the printing fluid, which need not be flushed after use, so that any remaining content is not lost. The contents are delivered as directly to the nozzle as possible, so that very little is lost. It is not necessary to fill a dish or container first in order to suck up the fluid. An added advantage of the assembly according to the invention is that it requires less dexterity to charge it with printing fluids. This in itself reduces the amount of wastage due to inadvertent spills.

In a preferred embodiment, the channel arrangement includes at least one switch for selectively supplying fluid to an individual nozzle from one of the container and a further reservoir.

Thus, it is not necessary to remove the cartridge including the container in order to pass a different fluid through the nozzle or part of the channel arrangement immediately preceding it. This means that the printing fluid of the container that remains in the part of the channel arrangement upstream of the switch can remain there for subsequent use whilst a different fluid is passed through the nozzle or at least the downstream section of the channel arrangement. That part consequently need not be flushed so often, removing a cause of wastage.

A preferred embodiment includes a plurality of adapter structures for releasable connection to respective cartridges including a container for holding a printing fluid, wherein each adapter structure is configured to co-operate with the cartridge to provide a passage between the container and channel arrangement upon connection, and wherein the channel arrangement is suitable for providing separate respective fluid paths from each of the provided passages to respective individual nozzles.

Thus, it is possible to print a surface with a dense pattern of different functional fluids. This can be done in one print run, without interchange of any cartridges. Because the channel arrangement is suitable for providing separate respective fluid paths from each of the provided passages to respective individual nozzles, and the face presents an array of nozzle orifices, dense printing is achievable with little or no movement of the print head.

In a preferred variant of this embodiment, each of the fluid paths comprises a switch for selectively providing fluid from one of the provided passage and a reservoir common to a plurality of the individual nozzles.

Thus, an inexpensive fluid to be passed through several of the nozzles and/or channel arrangement parts leading to the nozzles need not be provided in the same cartridge as the printing fluids. An example of such an inexpensive fluid is a cleaning fluid.

According to another aspect, the print head assembly is characterized in that at least one reservoir arrangement includes a cartridge including a container for holding a printing fluid and an adapter structure in the print head for releasable connection to the cartridge, wherein the adapter structure and cartridge are configured to provide a passage between the container and channel arrangement upon connection.

In a preferred embodiment, the cartridge includes at least one further container for holding a fluid, wherein the adapter structure and cartridge are configured to provide a passage between one of the further containers and channel arrangement upon connection in a certain manner.

Thus, it is possible to pass more than one fluid through the print head without changing the cartridge, which is more efficient.

In a preferred variant, the connection between the adapter structure and cartridge is reconfigurable to provide alternatively a passage between one of the containers and the channel arrangement.

Because the connection is reconfigurable, it is maintained whilst changing the fluid supply from one container to the other. This prevents spillage.

In a preferred embodiment, at least one container includes at least one wall formed at least partly by a pierceable self-sealing septum.

Thus, the adapter structure may include a component for piercing the wall to access the contents of the container. This is an easy and effective way of providing a fluid-tight connection between the print head and the container. Because the septum is self-sealing, any remaining contents of the container do not spill after use. This allows further use. In an embodiment where the cartridge includes multiple containers and the septum separates the containers, mixing between the container contents is prevented.

According to another aspect of the invention, there is provided a cartridge presenting all the features of the cartridge disclosed in any one of claims 5-9 and being thus constructed and evidently intended for use in the print head assembly according to the invention.

According to another aspect, the invention provides a printer including a print head according to the invention and/or a print head assembly according to the invention.

The invention will now be explained in further detail with reference to the accompanying drawings, in which:

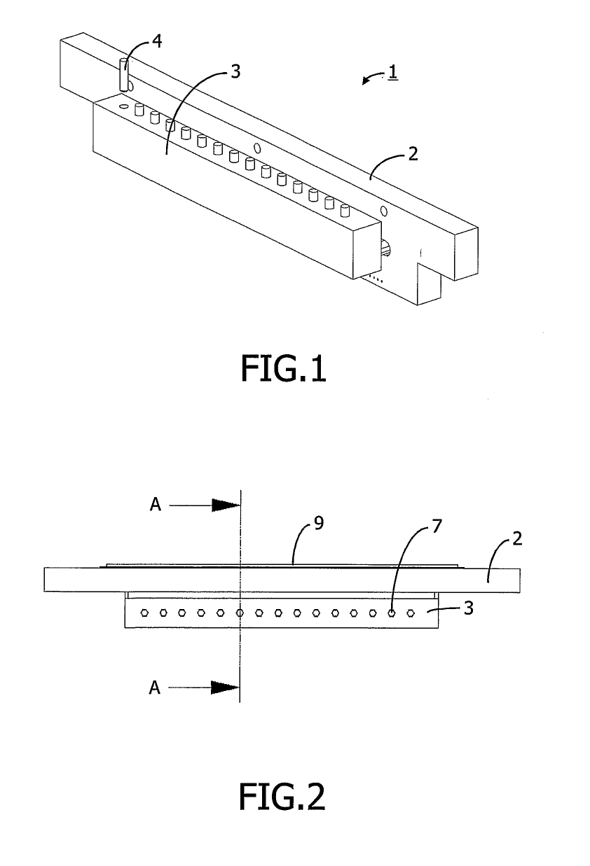

FIG. 1 is a perspective view of an embodiment of a print head assembly;

FIG. 2 is a top plan view of the print head shown in FIG. 1;

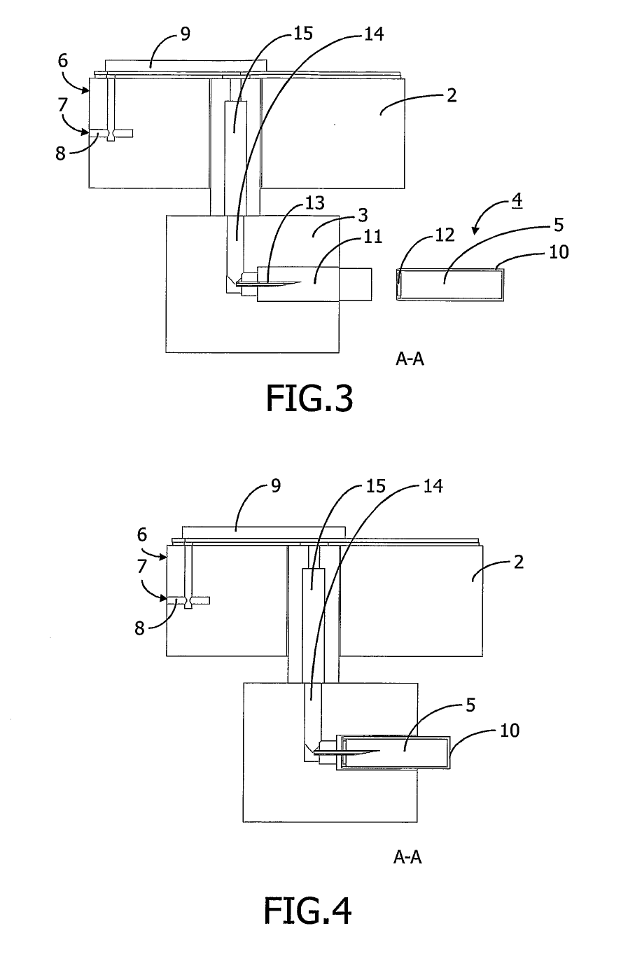

FIG. 3 is cross-sectional view along line A-A in FIG. 2, with a cartridge shown prior to engagement with the print head;

FIG. 4 is a cross-sectional view similar to that of FIG. 3 with the cartridge inserted;

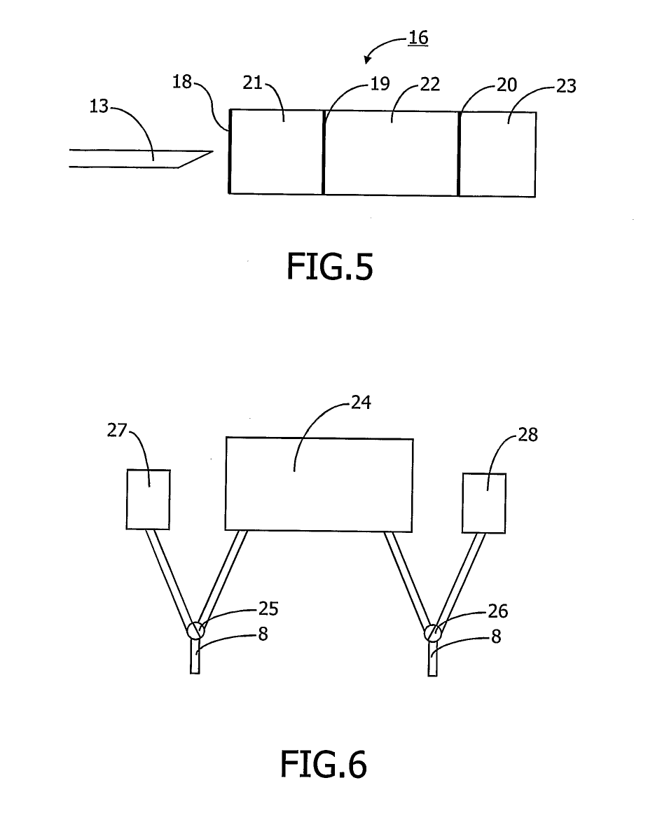

FIG. 5 is a schematic diagram of an alternative embodiment of a cartridge; and

FIG. 6 is a schematic diagram illustrating an aspect of a favorable embodiment of the print head.

A print head assembly 1 as shown in FIGS. 1 and 2 includes a print head in the shape of a main print head body 2 with an adapter block 3 fixed to it. The adapter block 3 is arranged to accommodate a plurality of cartridges 4. Each cartridge 4 includes at least one container 5 (see FIGS. 3-4) for holding a printing fluid.

The print head assemblies 1 described herein find use in printing functional fluids onto a substrate, as opposed to inks. One example of such use is in preparing a biological assay. In that case a number of drops of different substances are deposited side by side on a small area of a substrate. The molecules of each substance bind to a specific target molecule, so that a small area of a substrate is suitable for testing a sample for the presence of a large number of different target molecules. The substances used to test for the presence of the target molecules are difficult to prepare and are consequently extremely expensive. To be able to test for a large number of target molecules on a small area of substrate (useful as it requires a smaller sample), the droplets must be deposited as closely together as possible without mixing.

Using the print head according to the present invention, a disposable (spotted membrane mounted in a fluid cell) can be made for use in a set-up to analyse human samples for the presence of bacteria, viruses, fungi etc causing infectious diseases. This is done by extracting the DNA content of a patient sample and subsequently multiplying certain gene sequences and providing them with fluorescent markers. This fluid is then forced to flow through a membrane with different capture probes on it, which have been printed on the membrane. The labelled DNA molecules adhere to the spot covered with the material that attracts only the molecule considered. The captured molecules are read by illumination with a light source. A CCD camera records the fluorescent pattern. The recorded pattern is a characteristic of the composition of the biofluid, in this case with a bacterium, virus, fungus etc.

Another use of the print head assemblies 1 described herein is in the preparation of devices including conducting or semi-conducting components made, for instance, of organic materials. Examples of such devices include display panels, especially flexible ones, new types of solar panels, etc. In each case, the materials are to be assembled in very fine structures, for which printing techniques are well suited, provided the technique allows for a sufficient resolution. Because of the advanced, and often experimental, nature of the materials involved, suspensions or solutions containing these functional materials, can be extremely expensive.

The print head body 2 is similar to those commonly found in ink-jet printers, and is suitable for applying ink-jet printing techniques. As shown in FIGS. 2-4, a face 6 of the print head body 2 presents an array of nozzle orifices 7, terminating nozzles 8 formed in the print head body 2. Ink-jet printing techniques are particularly suited to the applications described above, because of the high frequency of droplet generation and small size of droplets. Typical droplet diameters are of the order of 20-40 μm. Because the nozzles 8 are formed in a single print head block 2, the nozzle orifices 7 are spaced much closer together, providing high resolutions. Typical nozzle spacing is within the range of 100 μm-500 μm.

The nozzle orifices 7 are preferably arranged in a substantially straight line, because in that case the pitch of the spots on the substrate on which the functional fluids are to be deposited can be varied in a uniform manner for all nozzles, simply by tilting the print head assembly 1 in the direction of motion of the substrate.

The print head assembly 1 further includes a channel plate 9. The channel plate 9 is arranged to provide individual fluid paths to each of the nozzles 8. In addition, the channel plate 9 preferably includes ejection arrangements (not shown) for ejecting droplets of the functional fluids through the nozzles 8. Either a thermal or a micro-electro-mechanical ejection arrangement may be used. An example of the former is described in U.S. Pat. No. 4,532,530; an example of the latter is known from U.S. Pat. No. 5,063,396.

In use, the print head assembly 1 is mounted on a carriage of a printer device (not shown). The printer device contains the means for controlling the printing process. The print head assembly 1, in this particular embodiment the channel plate 9, is adapted for individually activating the ejection arrangements. Suitable leads and contact points (not shown) allow for connection of a cable providing activation signals that individually address the ejection arrangements. An advantage of individually addressable ejection arrangements is that the printing of complex patterns is facilitated.

The cartridges 4 as shown in FIGS. 3 and 4 each include a container 15, filled with the functional fluid. The adapter block 3 includes a number of adapter structures each arranged for releasable connection to a cartridge 4. In the examples shown herein, the cartridge 4 has a cylindrical outer wall 10. Each adapter structure includes a recess 11. The recess 11 is sized and shaped to envelope at least part of the outer wall 10 in closely fitting relationship. Other types of adapter structure and cartridge are conceivable. A cartridge could have a screw thread for screwing it into a cavity with a matching thread. Alternatively, snap connections are conceivable, or the adapter structure could include a projecting hollow pipe fitting tightly into a passage leading to the container 5. It is noted that all alternatives also hold the cartridge in a fixed position relative to the print head, in order to minimize the chance of leakage occurring.

Returning to the embodiment set out herein in detail, the cartridge at one end includes an outer wall including a septum 12. Preferably, the septum 12 is of a pierceable self-sealing type. Such types of septum 12 are known per se in the field of medicine, where they are used to seal off vials containing preparations to be injected with a hypodermic syringe. The septum can, for example, be made of compressed silicone rubber.

As in the field of medicine, a hollow needle 13 is used to provide a passage between the container 5 and a passage through the channel arrangement leading to a nozzle 8 upon connection of the cartridge 4 to the print head. FIG. 3 shows the print head assembly 1 just prior to insertion of the cartridge 4. FIG. 4 shows the cartridge 4 in position for printing. A first channel section 14 through the adapter block 3 and a second channel section 15 through the print head body 2 provide supply fluid connect the passage provided by the hollow needle 13 to an individual nozzle 8 via the channel plate 9.

It is noted that the container 5 is provided within a substantially gas-tight enclosure. The adapter structure on the print head and the mating part of the cartridge 4 are configured to provide a substantially gas-tight connection. To fill the print head channels 14, 15 and channel plate and the channel 8 with fluid the part of the container outside 13 is squeezed. The elastic deformation of the wall of container 10 ensures that the pressure in a nozzle 8 and the passage from the nozzle 6 to the associated container 5 is lower than the pressure of the print head assembly's environment. Due to this lower pressure, wetting of the face 6 presenting the nozzle orifices 7 is prevented. This effect is achieved regardless of the particular orientation of the print head assembly 1 when mounted on a carriage in a printer device. That is to say that the cartridges 4 may lie above or below the level of the nozzles 8 in use. In principle an auxiliary source of underpressure is not needed either. Another method to end up with the same effect namely a under pressure at the nozzle is to provide the backside of container 10 with a pierceable self sealing septum. Through this septem a hollow needle is forced. This needle is connected to a pressure regulator, allowing for filling and purging the print head and keeping the meniscus under-pressure.

FIG. 5 shows a cartridge 16 of an alternative type. This cartridge 16 also has a cylindrical outer wall 17 and an outer wall with a first septum 18 at one end. It also includes a second septum 19 and third septum 20. Each of these septums 18-20 is of pierceable self-sealing construction. The second septum 19 separates a first container 21 for holding a fluid from a second container 22 for holding a fluid. The third septum 20 separates the second container 22 from a third container 23 for holding a fluid.

This particular configuration is advantageous, as the first container 21 and third container 23 can hold a cleaning fluid whereas the second container 22 should hold a functional fluid, e.g. a biological fluid. In this manner, all fluids needed to use the print head assembly 1 to eject droplets of a particular functional fluid are contained in one cartridge 16. The print head assembly 1 is ready for further use after all three fluids have been passed through a passage from their respective containers 21-23 through the first and second channel sections 14,15, the channel plate 9 and the associated individual nozzle 8.

The arrangement shown in FIG. 5 enables the connection between the adapter block 3 and the cartridge 16 to be reconfigured whilst keeping the cartridge 16 connected. The cartridge 16 need simply be pushed further into the recess 11, so that the hollow needle 13 penetrates each of the three septums 18-20 in turn. None of the fluids in the three containers 21-23 is spilt. They are also kept neatly separated from each other. The use of separate containers 21-23 allows precise doses of fluid to be introduced into the print head assembly 1.

Additionally or alternatively, certain embodiments include a reservoir 24 (FIG. 6) common to several nozzles 8. This means that the channel arrangement provided in the channel plate 9, print head body 2 and adapter block 3 is reconfigurable to provide a fluid connection between the common reservoir 24 and one or more of these nozzles. In certain embodiments the common reservoir 24 is integrated into the print head body 2 or adapter block 3. In an alternative embodiment it is external to the print head and connected to it by a, preferably flexible, tube. In an embodiment not shown, the common reservoir 24 is formed by a cartridge similar to the cartridges 4,16, but with a larger capacity.

Switches 25,26 allow fluid to be selectively provided to individual nozzles 8 from either the common reservoir 24 or respective associated individual reservoir arrangements 27,28. These reservoir arrangements include an adapter structure in the print head, i.e. the arrangement of a recess 11 and hollow needle 13, and one of the cartridges 4,16 shown in FIGS. 3,4 and FIG. 5, respectively. Preferably, the switches 25,26 operate according to the principle of electro-wetting.

The configuration of FIG. 6 is advantageous for providing an inexpensive cleaning fluid to all the nozzles and channels leading to them from the common reservoir 24. Of course, another type of fluid could also be provided, e.g. a fluid for providing a finishing layer over all the different individual droplets. This configuration avoids having to package such fluids in needlessly precise dosages, and is thus more efficient.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

It is observed that the precise implementation of the print head, print head assembly and cartridge may vary according to the particular application the use has in mind. For example, a micro-mechanical ejection arrangement would be more suitable for dispensing droplets of biological fluid, in order to avoid decay due to excessive heating. Also, it is noted that cartridges 4,16 of both types may be used concurrently in one print head assembly 1.

1. Print head having a face (6) presenting an array of nozzle orifices (7) and configured for mounting a number of associated ejection arrangements, each ejecting droplets of printing fluid through the associated nozzle (8) when activated, wherein the print head includes at least parts of a plurality of reservoir arrangements (27,28) for holding printing fluids to be ejected and a channel arrangement (9,14,15) for supplying a printing fluid from a reservoir arrangement (27,28) to an individual nozzle (8), characterized in that the print head includes at least one adapter structure (11,13) for releasable connection to a cartridge (4;16) including a container (5;22) for holding a printing fluid, wherein the adapter structure (11,13) is configured to co-operate with the cartridge (4;16) to provide a passage between the container (5;22) and channel arrangement upon connection.

2. Print head according to claim 1, wherein the channel arrangement includes at least one switch (25,26) for selectively supplying fluid to an individual nozzle (8) from one of the container (5;22) and a further reservoir (24).

3. Print head according to claim 1, including a plurality of adapter structures (11,13) for releasable connection to respective cartridges (4;16) including a container (5;22) for holding a printing fluid, wherein each adapter structure is configured to co-operate with the cartridge to provide a passage between the container and channel arrangement upon connection, and wherein the channel arrangement is suitable for providing separate respective fluid paths from each of the provided passages to respective individual nozzles.

4. Print head according to claim 3, wherein each of the fluid paths comprises a switch (25,26) for selectively providing fluid from one of the provided passage and a reservoir (24) common to a plurality of the individual nozzles (8).

5. Print head according to claim 1, suitable for printing biological fluids.

6. Print head assembly including
a print head having a face (6) presenting an array of nozzle orifices (7) and including
a number of associated ejection arrangements for each ejecting droplets of printing fluid through the associated nozzle (8) when activated,
the assembly including a plurality of reservoir arrangements (27,28) for holding fluids to be ejected, wherein the print head includes a channel arrangement (9,14,15) for supplying a printing fluid from a reservoir arrangement (27,28) to an individual nozzle (8), characterized in that at least one reservoir arrangement (27,28) includes a cartridge (4;16) including a container (5;22) for holding a printing fluid and an adapter structure (11,13) in the print head for releasable connection to the cartridge (4;16), wherein the adapter structure (11,13) and cartridge (4;16) are configured to provide a passage between the container (5;22) and channel arrangement (9,14,15) upon connection.

7. Print head assembly according to claim 6, wherein the cartridge (16) includes at least one further container (21,23) for holding a fluid, wherein the adapter structure (11,13) and cartridge (16) are configured to provide a passage between one of the further containers (21,23) and channel arrangement (9,14,15) upon connection in a certain manner.

8. Print head assembly according to claim 7, wherein the connection between the adapter structure (11,13) and cartridge (16) is reconfigurable to provide alternatively a passage between one of the containers (21-23) and the channel arrangement (9,14,15).

9. Print head assembly according to claim 6, wherein at least one container (4;16) includes at least one wall formed at least partly by a pierceable self-sealing septum (12;18-20).

10. Print head assembly according to claim 6 and including a print head having a face (6) presenting an array of nozzle orifices (7) and configured for mounting a number of associated ejection arrangements, each ejecting droplets of printing fluid through the associated nozzle (8) when activated, wherein the print head includes at least parts of a plurality of reservoir arrangements (27,28) for holding printing fluids to be ejected and a channel arrangement (9,14,15) for supplying a printing fluid from a reservoir arrangement (27,28) to an individual nozzle (8), characterized in that the print head includes at least one adapter structure (11,13) for releasable connection to a cartridge (4;16) including a container (5;22) for holding a printing fluid, wherein the adapter structure (11,13) is configured to co-operate with the cartridge (4;16) to provide a passage between the container (5;22) and channel arrangement upon connection.

11. Cartridge presenting all the features of the cartridge disclosed in claim 6 and being thus constructed and evidently intended for use in the print head assembly as claimed in claim 6.

12. Printer including a print head according to claim 1.
